(19) United States
(12) Patent Application Publication
(10) Pub. No.: US 2024/0049664 A1
(43) Pub. Date: Feb. 15, 2024

(54) INTELLIGENT AEROPONIC MICROGRAVITY & EARTH NUTRIENT DELIVERY (I-AMEND) SYSTEM FOR BIOREGENERATIVE SPACE LIFE SUPPORT AND EARTH APPLICATIONS

(71) Applicant: ARIZONA BOARD OF REGENTS ON BEHALF OF THE UNIVERSITY OF ARIZONA, Tucson, AZ (US)

(72) Inventors: Joel L. Cuello, Tucson, AZ (US); Yaser Mehdipour, Tucson, AZ (US); Chen-Han Shih, Tucson, AZ (US); Jack Welchert, Tucson, AZ (US); Kate Stalkfleet, Tucson, AZ (US); Sean Gellenbeck, Tucson, AZ (US); Torin Hodge, Tucson, AZ (US)

(21) Appl. No.: 18/547,611

(22) PCT Filed: Feb. 23, 2022
(86) PCT No.: PCT/US22/17458

§ 371 Date: Aug. 23, 2023

Related U.S. Application Data
(60) Provisional application No. 63/152,690, filed on Feb. 23, 2021.

(51) Int. Cl. A01G 31/02

(52) U.S. Cl. CPC A01G 31/02

(57) ABSTRACT

The Intelligent Aeroponic Microgravity & Earth Nutrient Delivery (I-AMEND) System is configured to enable the productive growth of crops on the Moon, Mars, and beyond as well as in space stations in low-Earth orbit, such as the International Space Station (ISS), and also on Earth. Principal components of the I-AMEND system may include an aeroponic chamber, a liquid nutrient emitter for emission of a liquid into the aeroponic chamber, and an air emitter for emission of a gust of air into the aeroponic system. The emitters may be positioned upstream or downstream of a plant port of the aeroponic chamber so as to direct the liquid onto or off of a surface of the plant root.

### CROSS-REFERENCES TO RELATED APPLICATIONS

This application claims benefit of U.S. Provisional Application No. 63/152,690 filed Feb. 23, 2021, the specification of which is incorporated herein in its entirety by reference.

### FIELD OF THE INVENTION

The present invention relates to aeroponic systems and devices. More specifically, the present invention relates to aeroponic systems and devices for use in microgravity environments as well as on the earth's surface.

### BACKGROUND OF THE INVENTION

Long-duration crewed missions on the Moon, Mars, and beyond require sustainable and resilient life support systems, including bioregenerative life support systems that encompass food crop production by way of engineered controlled environment. The crops serve as food for astronauts, but they can also play key roles in air regeneration and water purification and reuse within the extraterrestrial human habitat.

A significant limitation in growing crops in an extraterrestrial environment using nutrients dissolved in an aqueous medium delivered to the crops' roots via hydroponics or aeroponics is that the mechanics and behavior of liquid water under microgravity conditions such as on the Lunar or Martian surface deviate significantly from those under terrestrial conditions on Earth. While liquid water settles down and moves in bulk flow according to gravity on Earth, the microgravity condition of space causes bulk liquid water to break up into floating liquid droplets as governed by surface tension.

To this end, the Intelligent Aeroponic Microgravity & Earth Nutrient Delivery (I-AMEND) System was conceived and designed to enable the effective and efficient delivery of water, nutrients, and essential gases to the root biomass of crops for their productive growth on the Moon, Mars and beyond as well as in space stations in low-Earth orbit, such as the International Space Station (ISS), and also on Earth.

### BRIEF SUMMARY OF THE INVENTION

It is an objective of the present invention to provide systems, devices, and methods that allow for aeroponic crop growth in microgravity as well as terrestrial environments, as specified in the independent claims. Embodiments of the invention are given in the dependent claims. Embodiments of the present invention can be freely combined with each other if they are not mutually exclusive.

The I-AMEND System is a smart aeroponic nutrient delivery system that is designed to optimally deliver nutrients to the root systems of crops to enable them to grow and achieve maximum productivity under either microgravity or terrestrial conditions (FIG. 1).

Selected components of the I-AMEND System include an aeroponic chamber, a Liquid Nutrient Emitter, and an Air Emitter (FIG. 1). The following is a non-limiting example of how the system may work. The I-AMEND System first ejects pressurized liquid directed toward the root mass of the crops inside the aeroponic chamber via the Liquid Nutrient Emitter (FIG. 1, A), facilitating the physical contact between the liquid nutrients and the roots and thereby enabling the assimilation of the liquid nutrients by the roots. With bulk liquid water breaking up into floating droplets held together by surface tension under microgravity conditions and moving very slowly when they do, the subsequent burst of air from the Air Emitter (FIG. 1, B) pushes the liquid droplets through the root mass and moves them forward toward the roots of the next adjacent crop ahead. In one embodiment, a second Air Emitter is placed downstream of the first root mass (FIG. 2, C) to accomplish such. The timing and frequency of emissions by the Liquid Emitter and the two Air Emitters may be optimally coordinated to optimize the wetting of the root mass as well as the forward movement of the floating liquid droplets toward the next adjacent root mass. Further, the timing and frequency of emissions by the Liquid Nutrient Emitter and Air Emitters may be coordinated to optimize crop growth and productivity.

One of the unique and inventive technical features of the present invention is an aeroponic chamber with one or more liquid nutrient emitters and air emitters configured to direct liquid and air in one direction along the said aeroponic chamber. Without wishing to limit the invention to any theory or mechanism, it is believed that the technical feature of the present invention advantageously provides to achieve effective and efficient forward movement of floating liquid droplets (extraterrestrial condition) or bulk liquid (terrestrial condition) of nutrients and gasses through the plant roots and along the aeroponic channel. None of the presently known prior references or work has the unique inventive technical feature of the present invention.

Furthermore, the inventive technical feature of the present invention is counterintuitive. The reason that it is counterintuitive is because prior references teach away from the feature of the present invention. For example, prior systems teach the implementation of an aeroponic chamber comprising a liquid emitter that pumps liquid into the bottom of the chamber and air emitters that atomize the liquid in the bottom of the chamber into fog. In other words, prior systems teach aeroponic chambers comprising emitters that direct liquid and air in two directions. Furthermore, the air emitter taught by these prior systems is not a true air emitter, instead acting as more of a secondary liquid emitter since its main purpose is to eject liquid that is simply broken up into tiny liquid droplets. Prior systems teach these liquid atomizers for the sole purpose of conveying liquid droplets to make physical contact with the plant roots by moving the liquid in an upwards or downwards direction. This could NOT achieve effective and efficient forward movement of floating liquid droplets in microgravity conditions. On the contrary, the present invention implements an aeroponic chamber with one or more liquid nutrient emitters and air emitters configured to direct liquid and air in one direction along the said aeroponic chamber in either extraterrestrial conditions or terrestrial conditions. Furthermore, the present invention implements a true air emitter that is capable of dispensing pure air or gas into the aeroponic chamber and directing a forward movement of liquid from one end of the aeroponic chamber to the other. Thus, prior systems teach away from the inventive technical feature of the present invention and the inventive technical feature is counterintuitive.

The I-AMEND System was designed to have the following advantages under microgravity and also under terrestrial conditions:
1) Effective and efficient delivery of nutrients to crop roots;
2) Effective and efficient forward movement of floating aqueous droplets (extraterrestrial condition) or bulk liquid (terrestrial condition) of nutrients through the aeroponic channel;
3) Optimal crop growth and productivity per unit water and nutrients usage;
4) Convenient collection, recovery, recycling, and/or removal of liquid nutrients; and,
5) Applicability in small growth chambers and/or in large-scale crop production facilities in space vehicles or in human habitations on the Moon, Mars, and beyond as well as on Earth.

Any feature or combination of features described herein is included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows an illustration of selected principal components of an Intelligent Aeroponic Microgravity & Earth Nutrient Delivery (I-AMEND) system of the present invention. In this embodiment, the fixed Liquid Nutrient Emitters and Air Emitters are fixed in their emission angular directions but are slidable or movable along the longitudinal direction of the aeroponic channel.

FIG. 2 shows an illustration of the relative positioning of the Liquid Nutrient Emitters and Air Emitters within an I-AMEND system. In this embodiment, the Fixed Liquid Nutrient Emitters or Air Emitters are fixed in their emission angular directions but are slidable or movable along the longitudinal direction of the aeroponic channel.

FIG. 3 shows an illustration of the relative positioning of the Liquid Nutrient Emitters and Air Emitters within an I-AMEND system. In this embodiment, the Fixed Air Emitter and Fixed Composite Emitters are fixed in their emission angular directions but are slidable or movable along the longitudinal direction of the aeroponic channel.

FIG. 4 shows an illustration of the relative positioning of the Liquid Nutrient Emitters and Air Emitters within an I-AMEND system. In this embodiment, the Fixed Liquid Nutrient and Air Emitters, and Fixed Composite Emitters are fixed in their emission angular directions but are slidable or movable along the longitudinal direction of the aeroponic channel.

FIG. 5 shows an illustration of the relative positioning of the Rotational Liquid Nutrient Emitters and Air Emitters within an I-AMEND system. In this embodiment, the Rotational Liquid Nutrient and Air Emitters and Rotational Composite Emitters may each rotate on their longitudinal axis and are also slidable or movable along the longitudinal direction of the aeroponic channel.

FIG. 6 shows an illustration of the relative positioning of both Fixed Composite and Rotational Liquid Nutrient Emitters and Air Emitters within an I-AMEND system. In this embodiment, each of the Rotational Emitters may rotate on their longitudinal axis and, together with the Fixed Composite Emitter, are also slidable or movable along the longitudinal direction of the aeroponic channel.

FIG. 7 shows an illustration of a single Fixed Liquid Nutrient Emitter or Air Emitter of the I-AMEND system.

FIG. 8 shows an illustration of a Fixed Composite Liquid Nutrient Emitter or Air Emitter of the I-AMEND system.

FIG. 9 shows an illustration of a Rotational Liquid Nutrient Emitter or Air Emitter of the I-AMEND system.

FIG. 10 shows an illustration of a Rotational Concatenated Liquid Nutrient Emitter or Air Emitter of the I-AMEND system.

FIG. 11 shows an illustration of a Rotational Composite Liquid Nutrient Emitter and Air Emitter of the I-AMEND system.

FIG. 12 shows a schematic of a Vertical Hive (V-Hive) Green Box (Cuello et al., The University of Arizona) showing its movable/adjustable growing boards (G-boards), with aeroponic or hydroponic cultivation channels, and its movable/adjustable lighting boards (L-boards) with light sources.

FIG. 13 shows a NASA photograph of Astronauts harvesting salad crops from a grow cabinet in the International Space Station.

FIG. 14 shows an illustration of a miniaturized embodiment of a Vertical-Hive (V-Hive) Green Box (Cuello et al., The University of Arizona) with adjustable vertical lighting boards (L-boards) and adjustable growing boards (G-boards) inside a grow cabinet for the International Space Station or a future Lunar or Martian Human Habitat.

FIG. 15 shows an illustration of a miniaturized embodiment of a Vertical-Hive (V-Hive) Green Box (Cuello et al., The University of Arizona) with adjustable vertical lighting boards (L-boards) and adjustable growing boards (G-boards) inside a grow cabinet for the International Space Station or a future Lunar or Martian Human Habitat.

FIG. 16 shows an illustration of Life Grow Bots (Cuello et al., The University of Arizona) for applications on Earth and in future Lunar or Martian Human Habitats that may employ I-AMENDS as their nutrient delivery system.

FIG. 17 shows another illustration of Life Grow Bots (Cuello et al., The University of Arizona) for applications on Earth and in future Lunar or Martian Human Habitats that may employ I-AMENDS as their nutrient delivery system.

FIG. 18 shows an illustration of an embodiment of an I-AMEND aeroponic channel with a height-adjustable lid/top, where the channel is fitted with linear-type and rotational Liquid Nutrient Emitters and Air Emitters.

### DETAILED DESCRIPTION OF THE INVENTION

The Intelligent Aeroponic Microgravity & Earth Nutrient Delivery (I-AMEND) System was conceived and designed to enable the productive growth of crops on the Moon, Mars, and beyond as well as in space stations in low-Earth orbit, such as the International Space Station (ISS), and also on Earth. The following are selected original design features of the I-AMEND System: (1) The implementation of various combinations and permutations of different types of I-AMEND Liquid Nutrient and Air Emitters to achieve effective and efficient forward movement of floating liquid droplets (extraterrestrial condition) or bulk liquid (terrestrial condition) of nutrients and gases through the plant roots and along the aeroponic channel; (2) Allows for change of formulation of liquid nutrient solution delivered by the I-AMEND Liquid Nutrient Emitters to the root biomass in accordance with crop species, crop growth stage and desired crop characteristics; (3) Allows for change of formulation of gases (air, oxygen, carbon dioxide, ethylene, etc.,) delivered by the I-AMEND Air Emitters to the root biomass in accordance with crop species, crop growth stage and desired crop characteristics; (4) Allows for recovery of liquid nutrients and gasses downstream of the I-AMEND channel for recirculation, reuse or removal; (5) Allows for installation of sensors, cameras and other small electronic instruments or devices either within the I-AMEND channel or outside the I-AMEND channel if made of transparent material (e.g., glass, polyvinyl chloride, polycarbonate, etc.) for data collection (e.g., electrical conductivity, root biomass, root porosity, etc.) for the purpose of data analytics, artificial intelligence and/or automation for optimization of crop growth performance; and, (6) Applicability in small growth cabinets or growth chambers and/or in large-scale crop production facilities either on Earth or in space vehicles, space stations or in future human habitations on the Moon, Mars and beyond.

The present invention may comprise a plurality of additional electronic instruments. For example, the present invention may further comprise one or more small solenoid valves for controlling the flow rate of the air and liquid emitters, a pump to control water movement between the reservoir and into the liquid emitters, an ultraviolet (UV) filter to clean the recycled solution, one or more peristaltic pumps to add fertilizer and adjust pH levels in the liquid reservoir, or a combination thereof.

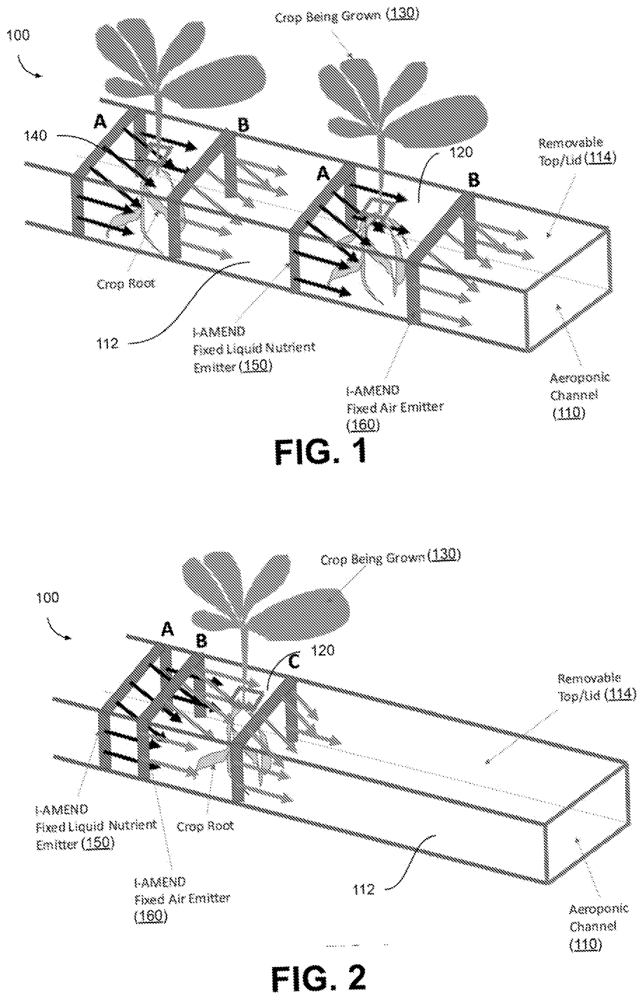

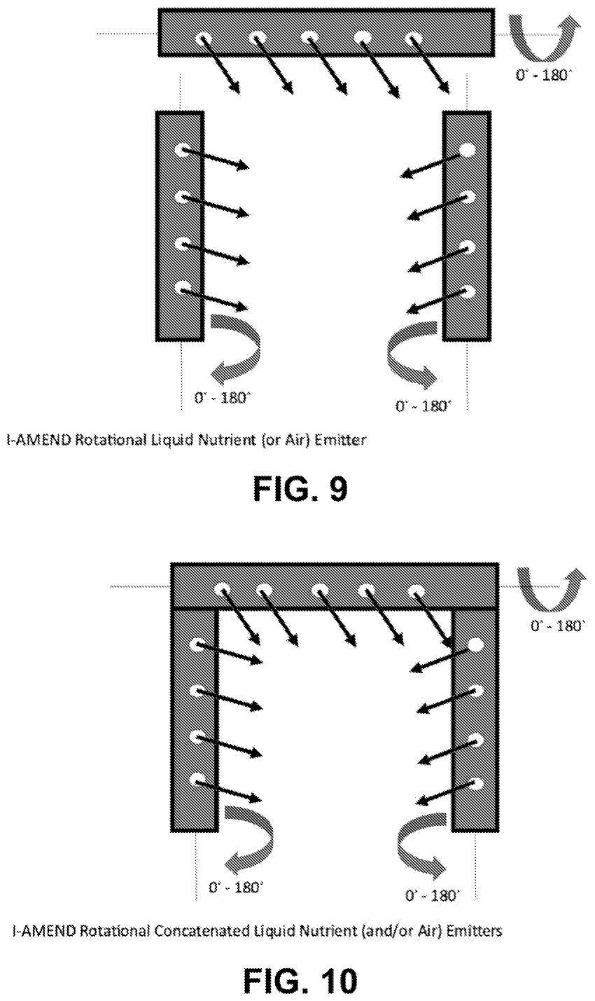

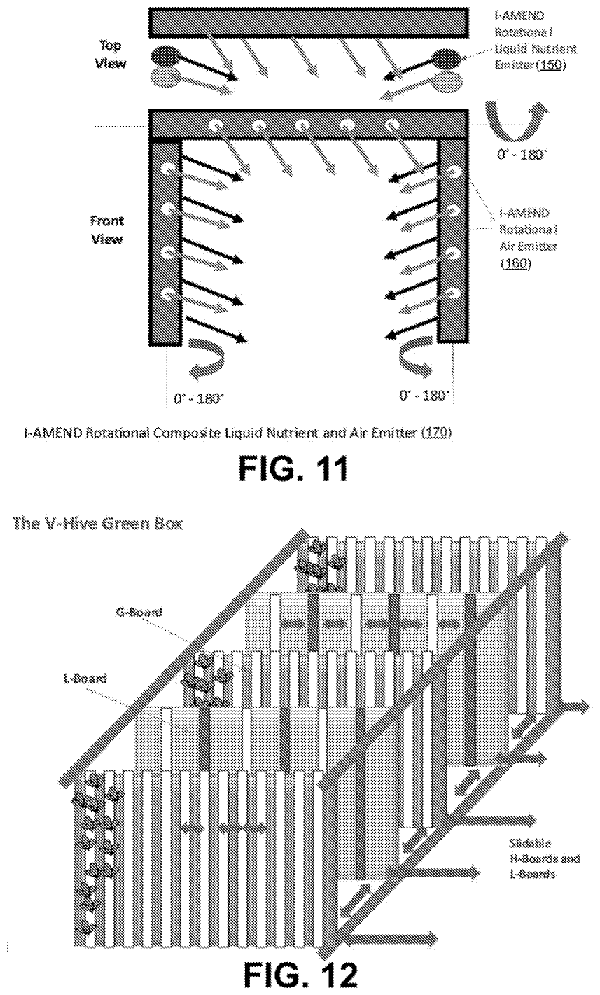

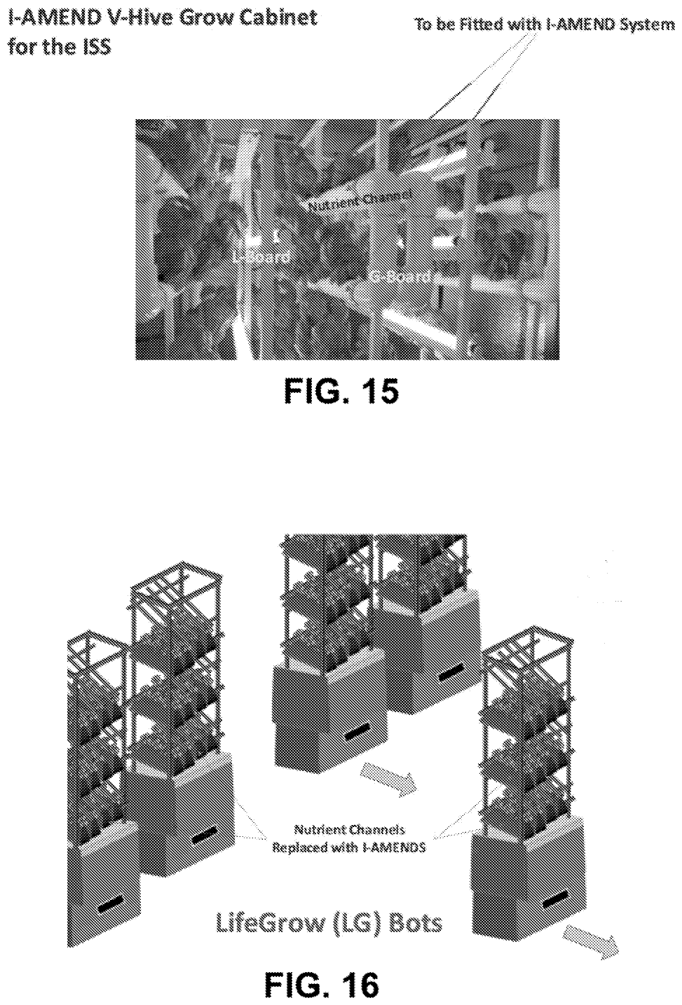

Referring to FIGS. 1-18, the present invention features various types of Liquid Nutrient Emitters or Air Emitter—including (1) Fixed, (2) Fixed Composite, (3) Rotational, (4) Rotational Concatenated, and (5) Rotational Composite. These figures also illustrate the various embodiments for the arrangements or relative positioning of the Liquid Nutrient Emitters and Air Emitters within the I-AMEND System.

### I-AMEND System Emitters

The I-AMEND System's Liquid Nutrient Emitters and Air Emitters may have various combinations of the following combinatorial factors so as to design a whole range of embodiments of the I-AMEND System.

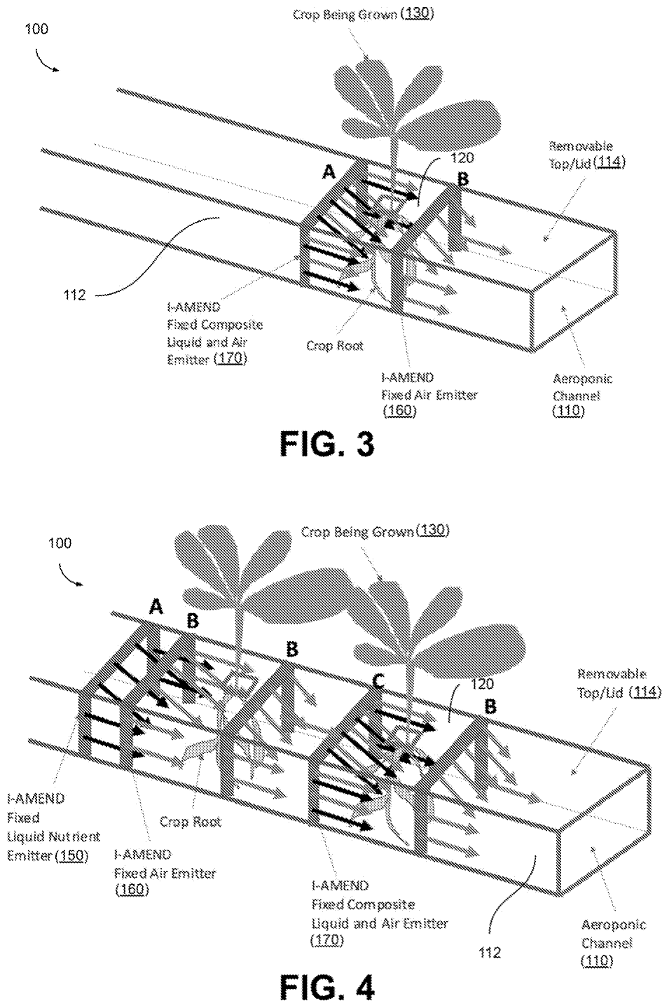

Emitter Type: Single (FIGS. 1, 2, 5, and 7), Composite (FIGS. 3, 5, 6, 8, and 11), or Concatenated (FIG. 10).

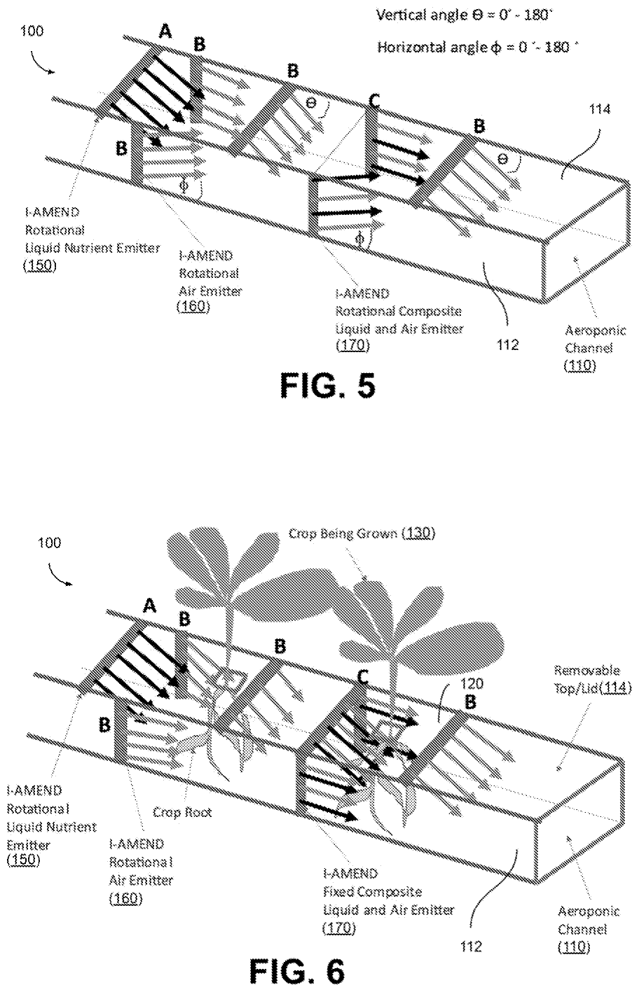

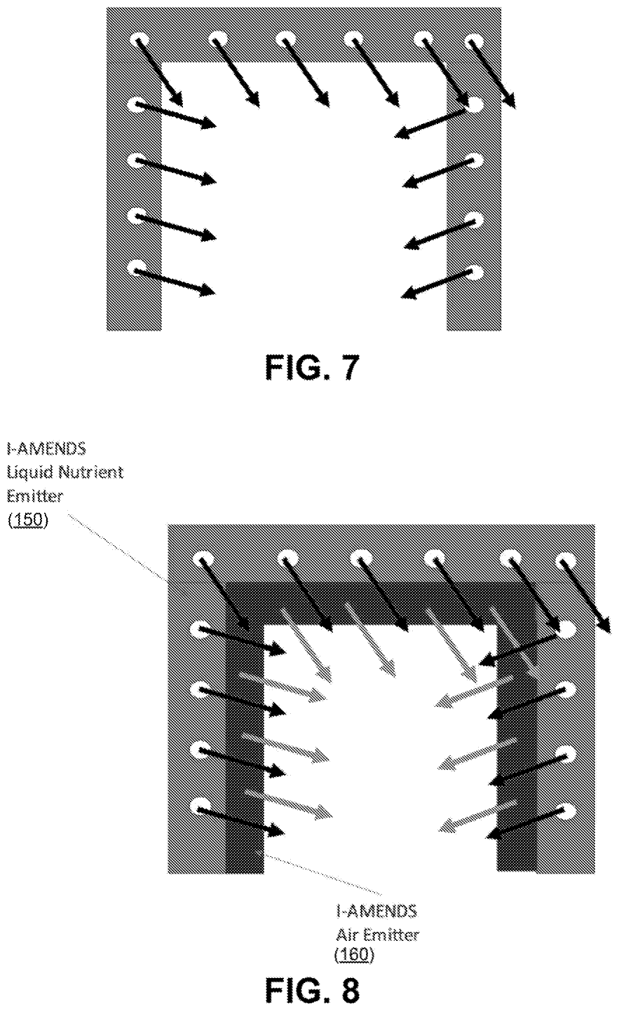

Emitter Geometry: U-Shaped (FIGS. 7 and 8, inverted U), Linear (FIGS. 5, 6, 9 and 10), Square, Rectangular, Circular, Semi-circular, Elliptical, or Semi-elliptical.

Emission Angular Direction: Fixed (FIGS. 1-4 and 7-8), or Rotational (FIGS. 5-6 and 9-11).

Emitter Channel Position Adjustability: Fixed or Movable.

Material: Ceramic, Polymer, or Metal.

Pore Design: Uniformly perforated or with specified locations for pores or holes. Pore size may range from micrometer to millimeter

Emissions Flow: Continuous or Intermittent.

Emissions Schedule: Alternating Liquid and Air, or Simultaneous Liquid and Air.

Emitter Spatial Sequence: Alternating Liquid Nutrient and Air Emitters, Combination Liquid and Air Emitters Upstream and Air Emitter downstream of root biomass, All Single Emitters, All Composite Emitters, Alternating Single and Composite Emitters, All U-Shaped Emitters, All Linear Emitters, Alternating U-Shaped, and Linear Emitters, All Fixed Emitters, All Rotational Emitters, Alternating Fixed, and Rotational Emitters, etc.

Height-Adjustable Lid/Top of the I-AMEND aeroponic channel (FIG. 18, A): This embodiment may be best suited when employing the linear rotational types of Liquid Nutrient Emitters or Air Emitters. The progressive height adjustment of the channel lid over time may be necessary for certain crop species that grow and accumulate significant mass and volume of root biomass over time. The height adjustment of the lid would enable the maintenance of a certain effective root porosity within the channel. The Liquid Nutrient Emitters and Air Emitters that are attached to the underside of the lid would naturally move in elevation together with the lid.

Machine vision and Artificial Intelligence (AI): Small video cameras may be installed in places within the I-AMEND channel, or outside if transparent channel material is used, to enable machine vision and Artificial Intelligence (AI) to determine the necessary height adjustment of the channel lid over time. Thus, based on the growing root biomass and its time-dependent density and porosity within the I-AMEND channel as deciphered through machine vision and AI, decisions would be made to determine the Liquid Nutrient and Air emission scheduling and frequency, the rates of rotation of which Emitters, the emission volumetric flow rates for which emitters, etc., to optimize the growth rate and productivity of the growing crops.

The machine vision/AI system may be trained by prior data of optimal air and liquid nutrient emission rates and plant rotation rates for specific crop types in order to automatically schedule emission and rotation without human intervention. Furthermore, video cameras may be used to view the volume of roots and the ratio of root mass to open area. This video data from the cameras may be fed into the AI system to determine when and how much the lid of the channel should be adjusted based on the root mass. Furthermore, the AI system may be used for data analysis purposes in order to analyze correlations between emission flow rates/frequency/scheduling/rotation and plant yield.

The present invention may comprise a computing device for containing and executing the machine vision/AI system. The computing device may comprise a processor capable of executing computer-readable instructions, a memory component comprising the machine vision/AI system and a plurality of computer-readable instructions, and a communication component capable of communicatively coupling the computing device to the video cameras.

Back-and-Forth Rotational Ability of linear-type Liquid Nutrients and Air Emitters: The rotational ability of linear-type Liquid Nutrients and Air Emitters may apply in back-and-forth directions.

Automation: All operations of the I-AMEND System may be fully automated, including (a) longitudinal movement or positioning of emitters within the I-AMEND channel; (b) emission rotational angular back-and-forth movement of linear emitters within the channel; (c) height adjustment of the channel lid/top; (d) emitters' emission scheduling and frequency; (e) rates of rotation of emitters; (f) emission volumetric flow rates of emitters; etc.

The present invention features an intelligent aeroponic microgravity and earth nutrient delivery (I-AMEND) system (100). In some embodiments, the system (100) may comprise an enclosed aeroponic chamber (110). The enclosed aeroponic chamber may comprise one or more sidewalls (112) having an upstream end and a downstream end, and a top lid (114), supported by the sidewalls (112). The system (100) may further comprise one or more plant ports (120) in the top lid (114), each configured to support a plant (130) such that a top portion of the plant (130) extends upwardly from the top lid (114), and a root portion of the plant (130) extends downwardly into the aeroponic chamber (110), and wherein an anchoring plug (140) fits snugly within each plant port (120) so as to physically support the plant (130) in place. The system (100) may further comprise one or more liquid nutrient emitters (150) supported by the aeroponic chamber (110) and have one or more liquid nutrient pores configured to emit a liquid into the aeroponic chamber (110) from the upstream end to the downstream end. In some embodiments, the liquid emitted into the aeroponic chamber (110) may comprise a hydroponic solution comprised of macro and micro nutrients such as nitrogen, phosphorus, potassium, calcium, magnesium, or a combination thereof. The system (100) may further comprise one or more air emitters (160) supported by the aeroponic chamber (110) and have one or more air pores configured to emit air into the aeroponic chamber (110) from the upstream end to the downstream end.

In some embodiments, each of the liquid nutrient emitters (150) may be fluidly connected with a liquid nutrient supply system configured to supply the liquid to the liquid nutrient emitters (150). In some embodiments, each of the air emitters (160) may be fluidly connected with an air or gas supply system configured to supply the air or gas to the air emitters (160). In some embodiments, the gas may comprise Mostly O₂ or CO₂. One or more of the emitters may be a single emitter that is configured to emit only the liquid or air. One or more of the emitters may be a composite emitter (170) that is configured to emit both liquid and air. One or more of the emitters may be a concatenated emitter (180). One or more of the emitters may have a u-shaped, linear, square, rectangular, circular, semi-circular, elliptical, or semi-elliptical geometry. One or more of the emitters may have a fixed emission angular direction. One or more of the emitters may have a rotational emission direction. One or more of the emitters may have a fixed position in the aeroponic channel. One or more of the emitters may have a movable position in the aeroponic channel. One or more of the emitters may comprise a ceramic, polymer, or metal material. One or more of the emitters may have a uniform pattern of pores.

In some embodiments, the pores may have a diameter between about 0.1 micrometers and 5 millimeters. One or more of the emitters may have a fixed position in the aeroponic channel. One or more of the emitters may be configured to provide a continuous or an intermittent flow. One or more of the emitters may be configured to provide a continuous or an intermittent flow whose volumetric flow rate varies over time. In some embodiments, the system (100) may be configured to provide alternating flow through the liquid nutrient emitters (150) and the air emitters (160). The system (100) may be configured to provide simultaneous flow through the liquid nutrient emitters (150) and the air emitters (160). The aeroponic chamber (110) may have both a liquid nutrient emitter (150) and an air emitter (160) upstream of each plant port (120). Each of the emitters may be configured to emit in a downstream direction. A portion of the emitters may be configured to emit in an upstream direction. In some embodiments, a small sensor, a camera, or another electronic device may be installed within the I-AMEND channel or outside the I-AMEND channel if the channel is made of transparent material, for data collection so as to enable data analytics, artificial intelligence, or automation for optimization of crop growth performance, or nutrient usage.

The present invention features a method of delivering nutrition to a crop (130) in an intelligent aeroponic microgravity and earth nutrient delivery (I-AMEND) system (100). In some embodiments, the method may comprise providing the crop (130) in the system (100) such that a root of the crop (130) is at least partially within an aeroponic chamber (110) of the system (100). The method may further comprise introducing a liquid to the aeroponic chamber (110), upstream of the root, via a liquid nutrient emitter (150), introducing air or oxygen-enriched air or carbon-dioxide-enriched air, or a combination thereof, upstream of the root via an air emitter (160), and introducing an air gust into the aeroponic chamber (110), upstream of the root, via an air emitter (160), so as to direct the liquid onto a surface of the root.

In some embodiments, the method may additionally comprise introducing an air gust into the root biomass in the aeroponic chamber (110) from either upstream of the root, downstream of the root, or both upstream and downstream of the root, so as to remove at least a portion of the liquid from the surface of the root and move it downstream. The method may further comprise the introduction of multiple air gusts either simultaneously or sequentially. The method may additionally comprise mechanically vibrating the root, so as to remove at least a portion of the liquid from the surface of the root.

### Example

The following is a non-limiting example of the present invention. It is to be understood that said example is not intended to limit the present invention in any way. Equivalents or substitutes are within the scope of the present invention.

Application 1: I-AMEND System in the Vertical-Hive (V-Hive) Green Box for the International Space Station (ISS) and Lunar & Martian Human Habitation (LMHH)

The Vertical-Hive Green Box (or V-Hive Green Box) (Cuello et al., The University of Arizona, patent pending) is a modular cultivation system that is intended for use in a Vertical Farm or Plant Factory for crop production on Earth or in an extraterrestrial environment (FIG. 12). One design advantage of the V-Hive Green Box is that it maximizes the number of crops that can be grown within the available volume of space of a growing unit or structure per unit time. Selected structural components of the V-Hive Green Box include a frame, movable/adjustable growing boards (G-boards) with aeroponic or hydroponic cultivation channels, and movable/adjustable lighting boards (L-boards) with the light sources, such as light tubes.

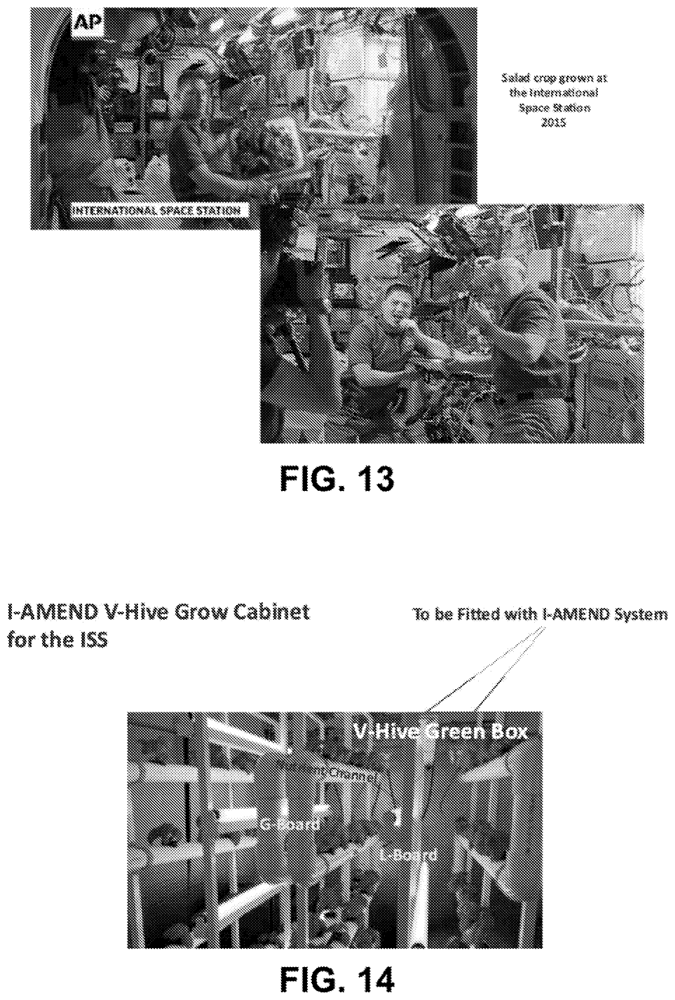

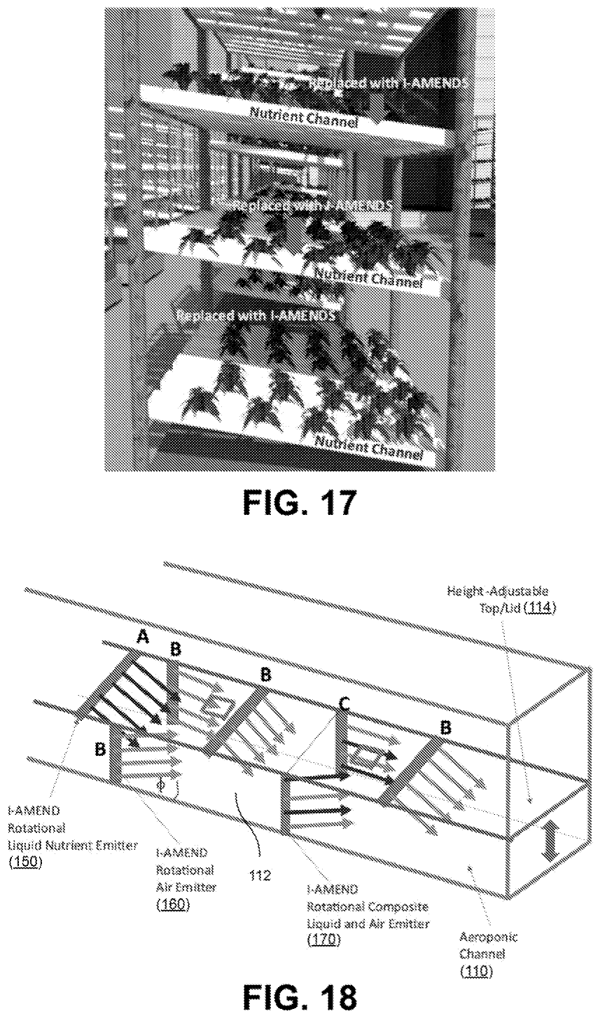

The I-AMEND System can appropriately and compatibly be used as the nutrient delivery system for the V-HIVE Green Box, including for use in a grow cabinet in the International Space Station (FIGS. 13-15) and also for controlled-environment food production systems in a future Lunar or Martian Human Habitat. The same is true for the use of the I-AMEND System as the nutrient delivery system for the mobile Life Grow Bots (Cuello et al., The University of Arizona) for both terrestrial and extraterrestrial applications (FIGS. 16-17).

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

1. An intelligent aeroponic microgravity and earth nutrient delivery (I-AMEND) system (100), the system (100) comprising:
a. an enclosed aeroponic chamber (110) comprising:
i. one or more sidewalls (112) having an upstream end and a downstream end; and
ii. a top lid (114), supported by the sidewalls (112);
b. one or more plant ports (120) in the top lid (114), each configured to support a plant (130) such that a top portion of the plant (130) extends upwardly from the top lid (114), and a root portion of the plant (130) extends downwardly into the aeroponic chamber (110);
c. one or more liquid nutrient emitters (150) supported by the aeroponic chamber (110) and having one or more liquid nutrient pores configured to emit a liquid into the aeroponic chamber (110) from the upstream end to the downstream end; and
d. one or more air emitters (160) supported by the aeroponic chamber (110) and having one or more air pores configured to emit air into the aeroponic chamber (110) from the upstream end to the downstream end.

2. The system (100) of claim 1, wherein each of the liquid nutrient emitters (150) are fluidly connected with a liquid nutrient supply system configured to supply the liquid to the liquid nutrient emitters (150).

3. The system (100) of claim 1, wherein each of the air emitters (160) are fluidly connected with an air or gas supply system configured to supply the air or gas to the air emitters (160).

4. The system (100) of claim 1, wherein one or more of the emitters is a single emitter that is configured to emit only the liquid or air.

5. The system (100) of claim 1, wherein one or more of the emitters is a composite emitter (170) that is configured to emit both liquid and air.

6. The system (100) of claim 1, wherein one or more of the emitters is a concatenated emitter (180).

7-8. (canceled)

9. The system (100) of claim 1, wherein one or more of the emitters has a rotational emission direction.

10. The system (100) of claim 1, wherein one or more of the emitters has a fixed position in the aeroponic channel.

11. The system (100) of claim 1, wherein one or more of the emitters has a movable position in the aeroponic channel.

12. (canceled)

13. The system (100) of claim 1, wherein one or more of the emitters has a uniform pattern of pores.

14-15. (canceled)

16. The system (100) of claim 1, wherein one or more of the emitters is configured to provide a continuous or an intermittent flow.

17. (canceled)

18. The system (100) of claim 1, wherein the system (100) is configured to provide alternating flow through the liquid nutrient emitters (150) and the air emitters (160).

19. The system (100) of claim 1, wherein the system (100) is configured to provide simultaneous flow through the liquid nutrient emitters (150) and the air emitters (160).

20. The system (100) of claim 1, wherein the aeroponic chamber (110) has both a liquid nutrient emitter (150) and an air emitter (160) upstream of each plant port (120).

21. (canceled)

22. The system (100) of claim 1, wherein one or more of the emitters are configured to emit in an upstream direction.

23. The system (100) of claim 1, wherein a small sensor, a camera, or another electronic device is installed within the I-AMEND channel or outside the I-AMEND channel if the I-AMEND channel is made of transparent material, for data collection so as to enable data analytics, artificial intelligence or automation for optimization of crop growth performance, or nutrient usage.

24. (canceled)

25. A method of delivering nutrition to a crop (130) in an intelligent aeroponic microgravity and earth nutrient delivery (I-AMEND) system (100), the method comprising:
a. providing the crop (130) in the system (100) such that a root of the crop (130) is at least partially within an aeroponic chamber (110) of the system (100);
b. introducing a liquid to the aeroponic chamber (110), upstream of the root, via a liquid nutrient emitter (150);
c. introducing air or oxygen-enriched air or carbon-dioxide-enriched air, or a combination thereof, upstream of the root via an air emitter (160); and
d. introducing an air gust into the aeroponic chamber (110), upstream of the root, via an air emitter (160), so as to direct the liquid onto a surface of the root.

26. The method of claim 25, wherein the method additionally comprises introducing an air gust into the root biomass in the aeroponic chamber (110) from either upstream of the root, downstream of the root, or both upstream and downstream of the root, so as to remove at least a portion of the liquid from the surface of the root and move it downstream.

27. The method of claim 26, wherein multiple air gusts are introduced either simultaneously or sequentially.

28. The method of claim 25, wherein the method additionally comprises mechanically vibrating the root, so as to remove at least a portion of the liquid from the surface of the root.
